(19) United States
(12) Patent Application Publication
(10) Pub. No.: US 2018/0270260 A1
(43) Pub. Date: Sep. 20, 2018

(54) Method and a System for Facilitating Network Security

(71) Applicant: WIPRO LIMITED, Bangalore (IN)

(72) Inventors: Sridhar GOVARDHAN, Bangalore (IN); Sunil VARKEY, Tiruvalla (IN)

(21) Appl. No.: 15/467,192

(22) Filed: Mar. 23, 2017

(30) Foreign Application Priority Data
Mar. 20, 2017 (IN) 201741009670

(51) Int. Cl. H04L 29/06; G06N 99/00

(52) U.S. Cl. CPC H04L 63/1425; G06N 99/005

(57) ABSTRACT

The method and system of present disclosure relate to facilitating network security. The method includes configuring a network comprising plurality of devices which are provided with sensors for detecting security threats. Further, security grid of the network is generated, in which, the sensors of one device may interact with sensors of other devices. The system may continuously monitor the activities of the devices and learn from them. Based on the monitoring and learning, behavior pattern is generated. Further, system captures current activity of the device and compare it with the behavior pattern to determine the deviation. The system may consider the other factors like context of the operating environment and occurrences of the same activity in other devices in the security grid to determine the genuineness of the deviation. If the device is determined to be anomalous, the system generates curative actions for addressing the abnormality of the device.

### TECHNICAL FIELD

The present subject matter is related, in general to network security and more particularly, but not exclusively to a method and system for facilitating network security.

In today's enterprise environment, use of computing devices has become a common practice. With the increase in operations of the enterprises, the number of the computing devices has also increased. This leads to complexity in managing the computing devices as a huge sensitive information is generated. The sensitive information is prone to cyber-attacks, and hence providing a network security to the computing devices has become a challenge in the enterprise environment.

Nowadays, the cyber-attacks have become more advanced and have increased the threat and losses in the enterprises. To address the security issues, several security products are deployed. However, due to the changing landscape of the enterprise environment it becomes a challenge for these traditional security products to address the security issues. Another challenge is faced due to rapid adoption of cloud based technologies in the existing enterprise environment.

### SUMMARY

Disclosed herein is a method of facilitating network security. The method includes configuring a network comprising a plurality of devices associated with the security system. Further, each of the plurality of devices is provided with one or more sensors for detecting one of more security threats or anomalies in behavior of the plurality of devices. The method further includes generating a security grid for the network by using the plurality of devices such that the one or more sensors of one device, of the plurality of devices, is peered with the one or more sensors of other devices. Further, the method includes building a behavior pattern corresponding to each of the plurality of devices. The behavior pattern is built by continuously monitoring and learning from one or more security related events being captured by the one or more sensors. Further, the method includes capturing an activity performed by at least one device of the plurality of devices. The method further includes identifying a context of an operating environment of the network when the activity is performed. The operating environment comprises one or more operating parameters of the network. The method further includes determining a deviation of the at least one device by comparing the activity with the behavior pattern associated with the at least one device. Further, the method includes determining a level of the deviation based on the context of the operating environment. The method further includes determining occurrences of the activity performed by the other devices, apart from the at least one device, of the plurality of devices. Further, the method includes tagging the at least one device as an anomalous device or a non-anomalous device based on the level of deviation and the occurrences of the activity.

Further, the present disclosure relates to security system for facilitating network security. The system comprises a processor and a memory communicatively coupled to the processor. The memory stores processor-executable instructions, which, on execution, causes the processor to configure a network comprising a plurality of devices associated with the security system. Further, each of the plurality of devices is provided with one or more sensors for detecting one or more security threats or anomalies in behavior of the plurality of devices. The processor further generates a security grid for the network by using the plurality of devices such that the one or more sensors of one device, of the plurality of devices, is peered with the one or more sensors of other devices. Further, the processor builds a behavior pattern corresponding to each of the plurality of devices. The behavior pattern is built by continuously monitoring and learning from one or more security related events being captured by the one or more sensors. The processor further captures an activity performed by at least one device of the plurality of devices. Further, the processor identifies a context of an operating environment of the network when the activity is performed. The operating environment comprises one or more operating parameters of the network. The processor further determines a deviation of the at least one device by comparing the activity with the behavior pattern associated with the at least one device. Further, the processor determines a level of the deviation based on the context of the operating environment. The processor further determines occurrences of the activity performed by the other devices, apart from the at least one device, of the plurality of devices. Further, the processor tags the at least one device as an anomalous device or a non-anomalous device based on the level of deviation and the occurrences of the activity.

Furthermore, the present disclosure relates to a non-transitory computer readable medium including instructions stored thereon that when processed by at least one processor cause a security system to perform the acts of configuring a network comprising a plurality of devices associated with the security system. Further, each of the plurality of devices is provided with one or more sensors for detecting one or more security threats or anomalies in behavior of the plurality of devices. The security system further generates a security grid for the network by using the plurality of devices such that the one or more sensors of one device, of the plurality of devices, is peered with the one or more sensors of other devices. Further, the security system builds a behavior pattern corresponding to each of the plurality of devices. The behavior pattern is built by continuously monitoring and learning from one or more security related events being captured by the one or more sensors. The security system further captures an activity performed by at least one device of the plurality of devices. Further, the security system identifies a context of an operating environment of the network when the activity is performed. The operating environment comprises one or more operating parameters of the network. The security system further determines a deviation of the at least one device by comparing the activity with the behavior pattern associated with the at least one device. Further, the security system determines a level of the deviation based on the context of the operating environment. The security system further determines occurrences of the activity performed by the other devices, apart from the at least one device, of the plurality of devices. Further, the security system tags the at least one device as an anomalous device or a non-anomalous device based on the level of deviation and the occurrences of the activity.

The foregoing summary is illustrative only and is not intended to be in any way limiting. In addition to the illustrative aspects, embodiments, and features described above, farther aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout tie figures to reference like features and components. Some embodiments of system and/or methods in accordance with embodiments of the present subject matter are now described, by way of example only, and regarding the accompanying figures, in which:

FIG. 1 shows an exemplary environment for facilitating network security in accordance with some embodiments of the present disclosure;

FIG. 2 shows a detailed block diagram illustrating a security system for facilitating network security in accordance with some embodiments of the present disclosure;

FIG. 3 shows a flowchart illustrating a method for facilitating network security in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a security system for facilitating network security. The network security may be provided in any enterprise or to a network like internet of things (IOT) or Supervisory control and data acquisition (SCADA) network. Although, the method for facilitating the network security is described in conjunction with a server, the said method can also be implemented in various computing systems/devices, other than the server. In the enterprise like companies, firms, organizations and the like or in any network, a lot of computing devices like computers, laptops, desktops, smartphones and other computing devices are deployed. These computing devices may be located at same location or may be remotely located.

The computing devices, connected in a home network of the enterprise, interacts with each other and various sensitive information is transmitted and received. However, many a times, the computing devices are accessed outside the home network either due to requirement of project or due to wish of a user. In any of these scenarios, there may be a high risk of cyber-attacks or network threat on the computing devices. Even within the home network, the computing devices are prone to the security attacks. These attacks may be disastrous as they not only lead to date/information loss, but it may also result in financial losses for the enterprise.

To prevent the computing devices (i.e., user-devices or network devices) from such possible attacks, the present disclosure focusses on different perspectives. For example, from the device perspective, the present disclosure discloses a monitoring and learning technique in which the security system learns from the activities of the devices. This helps in understanding the behavior of the devices. On the other hand, from the network perspective, the present disclosure identifies context of an operating environment of the network. The operating environment includes the operating parameters like geography or location of devices, type of network, and type of applications and type of operating system running on the devices. Consideration of both the perspectives provides an overall view of the environment and it makes the network robust and secure.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

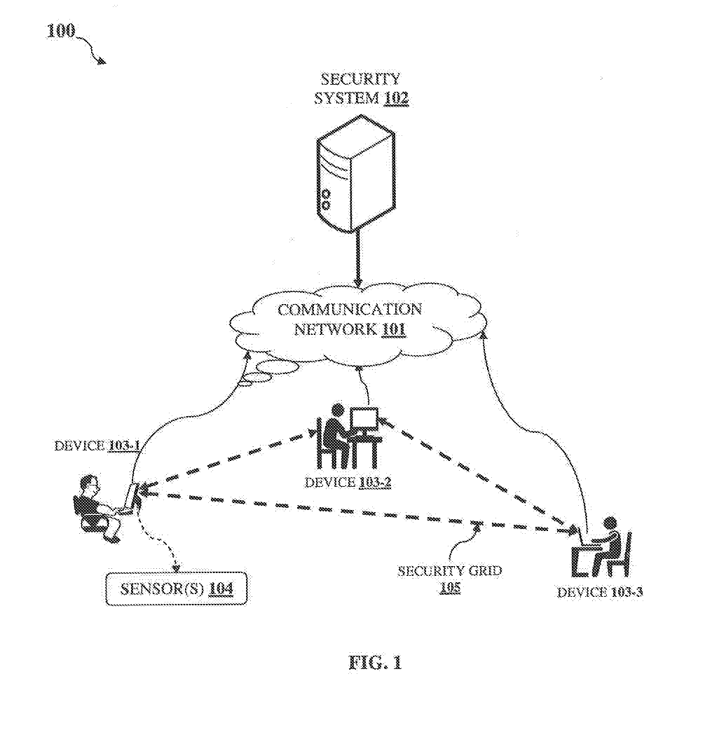

FIG. 1 shows an exemplary environment for facilitating network security in accordance with some embodiments of the present disclosure.

The environment 100 includes a communication network 101, a security system 102, device 103-1, device 103-2 and device 103-3. The device 103-1, device 103-2 and device 103-3 may be collectively and individually referred to as devices 103, are provided with one or more sensors 104. The one or more sensors 104 may include anti-malware sensor, anti-phishing sensor, anti-bot sensor, anti-data theft sensor, and anti-ransomware sensor. The devices 103 may be located at same location or may be remotely located. Further, a security grid 105 (shown as dotted lines) is generated for the network such that the sensors from one device 103 is connected with another device 103. According to embodiments of present disclosure, the security grid 105 generated may indicate different groups. For example, the security grid 105 may be a financial grid i.e., a grid indicating a group of devices 103 employed for financial activities. Similarly, other security grids 105 like mobile grid or administrator grid or any other grid may be generated based on the types of activities in which the devices 103 are involved. In FIG. 1, only one security grid 105 is shown for ease of understanding. However, any number of security grids 105 may be generated depending upon the size of the network.

In an embodiment, the security system 102 may monitor the activities of the devices 103 and security related events captured by the sensors 104. Based on the monitoring, the security system 102 learns about the behaviors of the devices 103 and may build a behavior pattern. This helps the security system 102 to differentiate between normal and abnormal activities performed by the devices 103. However, the security system 102 of the present disclosure not only rely on the behavior pattern, but it may also consider the various factors affecting the activities of the devices. The factor may be the operating environment of the network in which the devices 103 are deployed. Thus, based on the above, the security system 102 may identify abnormality in the devices 103 if any deviation is detected from the normal behavior.

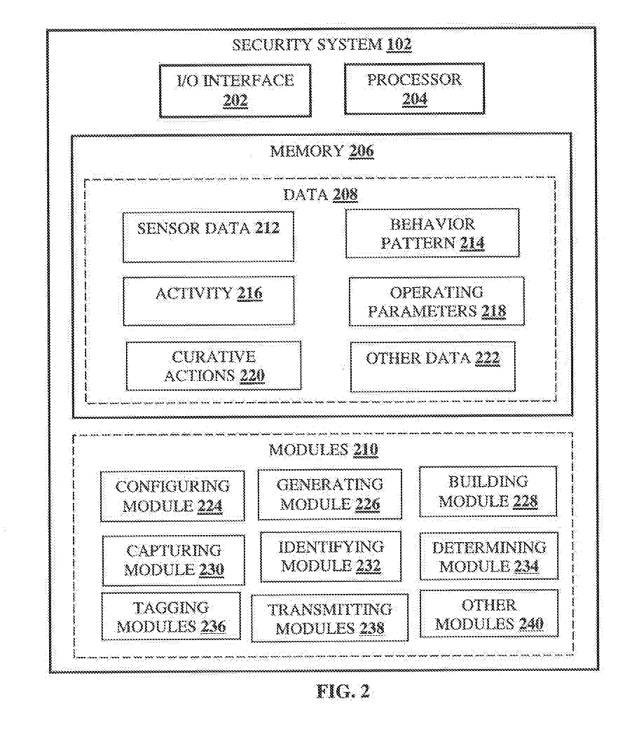

FIG. 2 shows a detailed block diagram illustrating a security system 102 for facilitating network security in accordance with some embodiments of the present disclosure.

The security system 102 includes an I/O interface 202, a processor 204, and a memory 206. The I/O interface 202 may be configured to receive sensor data 212 captured by one or more sensors 104 provided in the devices 103. The memory 206 may be communicatively coupled to the processor 202. The processor 202 may be configured to perform one or more functions of the security system 102 for facilitating network security. In one implementation, the security system 102 may include data 208 and modules 210 for performing various operations in accordance with the embodiments of the present disclosure. In an embodiment, the data 208 may be stored within the memory 206 and may include, without limiting to, sensor data 212, behavior pattern 214, activity 216, operating parameters 218, curative actions 220, and other data 222.

In some embodiments, the data 208 may be stored within the memory 206 in the form of various data structures. Additionally, the data 208 may be organized using data models, such as relational or hierarchical data models. The other data 222 may store data, including temporary data and temporary files, generated by the modules 210 for performing the various functions of the security system 102.

In an embodiment, the sensor data 212 may include data captured by the one or more sensors 104 provided in the devices 103. Since the devices 103 may be involved in different activities, the various security related events occurred while performing the activities may be captured by the sensors 104 as a sensor data 212 and transmitted to the security device 102.

In an embodiment, the behavior pattern 214 may be generated based on continuous monitoring and learning from the security related events captured by the sensors 104. The behavior pattern indicates the nature of activities performed by the devices 103. This helps the security system 102 detect any abnormal behavior of the devices 103 due to any possible network security attacks.

In an embodiment, the activity 216 may be one or more operations performed by the devices 103. The activity 216 is captured by the security system 102 and further utilized for determining any deviation from the normal behavior.

In an embodiment, the operating environment includes the operating parameters 218 of the network in which the devices 103 are deployed. The operating parameters 218 may include geography or location associated with the devices, type of network, and type of applications and type of operating system running on the devices 103.

In an embodiment, the curative actions 220 may be a remediation package which includes different actions for addressing any abnormality detected in the devices 103. The curative actions 220 may include creating new policy, modifying an existing policy, deleting files, deleting processes, deleting registries, updating software modules installed in the devices 103 and the like.

In some embodiments, the data 208 may be processed by one or more modules 210 of the security system 102. In one implementation, the one or more modules 210 may be stored as a part of the processor 204. In another implementation, the one or more modules 210 may be communicatively coupled to the processor 204 for performing one or more functions of the security system 102. The modules 210 may include, without limiting to, a configuring module 224, a generating module 226, a building module 228, a capturing module 230, an identifying module 232, a determining module 234, a tagging module 236, a transmitting module 238, and other modules 240.

As used herein, the term ‘module’ refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 240 may be used to perform various miscellaneous functionalities of the security system 102. It will be appreciated that such modules 210 may be represented as a single module or a combination of different modules.

In an embodiment, the configuring module 224 may configure a network comprising a plurality of devices 103 associated with the security system 102. Each of the plurality of devices 103 is provided with one or more sensors 104. The sensors 104 may detect one or more security threats or anomalies in behavior of the plurality of devices 103. Further, the sensors 104 may include, but not limited to, an anti-malware sensor, anti-phishing sensor, anti-bot sensor, anti-data theft sensor, and anti-ransomware sensor.

Once the network is configured, the generating module 226 may generate a security grid 105 for the network by using the plurality of devices 103. The security grid 105 is generated such that the sensors 104 of one device 103, of the plurality of devices 103, is peered with the one or more sensors 104 of other devices 103. The generation of the security grid 105 may allow the devices to interact with each other for sharing any relevant information. The security grid 105 may also help the security system 102 to quickly enquire amongst the devices 103 if any malicious activity is detected in any one device 103.

Based on the security grid 105 generated, the security system 102 continuously monitors the activities of the devices 103. The devices 103 may start interacting with each other. During the interaction, the devices 103 may go through various security related events associated with network environment, processes, services, registry, and hardware interrupts. All the events may be captured by the sensors 104 provided in the devices 103. For example, the device 103 may receive an email from an unknown sender. In this case, the anti-phishing sensor of the device 103 may monitor the email closely and may capture the event of receiving of email from unknown sender. In another event, the user may read that email and may click on a link (URL) mentioned in the email. This may further lead to other security related events like downloading of an office document, opening and executing a script, and connecting to a malicious website. In this case, the anti-bot sensor of the device 103 may capture such events and may stop the service and inform the abnormality to the security system 102. All the data captured by the sensors 104 may be referred as sensor data 212. According to embodiments, the sensor data 212 may be captured and transmitted to the security system 102 for analysis. The security system 102 may create a log of the sensor data 212 and may analyze from time to time.

The aforementioned events are not only continuously captured and monitored by the security system 102, but it also lets the security system 102 to learn (i.e., self-learning) from such continuous monitoring. Based on the continuous monitoring and learning, the building module 228 of the security system 102 may build a behavior pattern 214 corresponding to each device 103 of the plurality of devices 103. The building of the behavior pattern 214 may help the security system 102 understand about the routine activities being performed by each of the plurality of devices 103.

Once the behavior pattern 214 is built, the capturing module 230 of the security system 102 may capture an activity performed by the plurality of devices 102. The activity may indicate the current activity being performed by the device 102. For example, the activities may include login activity, email reading, opening of an attachment, browsing internet, visiting website, downloading software, and installing software on the device 103. It must be understood to a person skilled in art that the capturing module 230 may also capture any activity performed by the device 103. The captured activities are used for determining any deviation or abnormality in the behavior of the devices 103.

However, the security system 102 is not only dependent upon the current activities captured for determining the deviation, but it also considers the operating environment of the network. For example, the identifying module 232 of the security system 102 may identify a context of the operating environment of the network once the activity is performed and captured. The operating environment includes one or more operating parameters 218 of the network. For example, the operating parameters 218 may include geography or current location of the devices 103, type of network, and type of applications and type of operating systems running on the devices 103. The consideration of the operating environment makes the security system 102 mature and robust while determining the abnormality in the devices 103.

In next step, the determining module 234 of the security system 102 may determine the deviation of any device 103 by comparing its activity with the behavior pattern associated with that device 103. This provides clarity to the security system 102 that whether the device 103 has been deviated from its normal behavior as per the behavior pattern 214 built for that device 103. Even if it is determined that device 102 has been deviated from its normal behavior, the security system 102 does not finalize the abnormality of the device 103 at this stage. This is because, there may be other perspectives or valid reasons also due to which such deviation is detected in the normal behavior.

To check with the valid reasons, the determining module 234 of security system 102 may now determine a level of the deviation based on the context of the operating environment. As discussed above, there may be different operating parameters 218 in which the devices 103 may operate. Post determining the level of deviation, the determining module 234 may now determine the occurrences of the activity in other devices 103 in the network. The consideration of the operating parameters 218 and occurrences is must before determining the genuineness of the deviation of the device 103. For example, if the deviation is determined doe to change in location and operating system of the device 103, and such change is genuine or in other words required as per the project requirement, the device 103 may not be determined as the abnormal device.

However, if the deviation is determined to be not genuine, the tagging module 236 may tag the device 103 as an anomalous device. For example, if the device 103 in the entire security grid 105 is the only device which has changed its operating system or changed its location without any valid requirement, such device 103 is tagged as the anomalous device. Further, it may also happen that the anomalous device may affect other devices in the security grid 105. Thus, once the device 103 or any other devices 103 is determined to be anomalous, the curative actions 220 is required to be taken.

According to an embodiment, the generating module 226 of the security system 102 may generate one or more curative actions 220 for the device 103 and the other devices 103 in order to address the anomaly detected in the behavior of that device 103 and the other devices 103 due to the deviation. The curative actions 220 may include creating new policies, modifying existing policies, deleting files present in the devices, deleting processes, deleting registries, updating software modules installed in the devices 103 and the like. Once the curative actions 220 are generated, the transmitting module 238 of the security system 102 may transmit the curative actions 220 to the device 103 and the other devices 103 determined to be anomalous. This way the security device 102 facilitates the network security to devices 103 connected in the network.

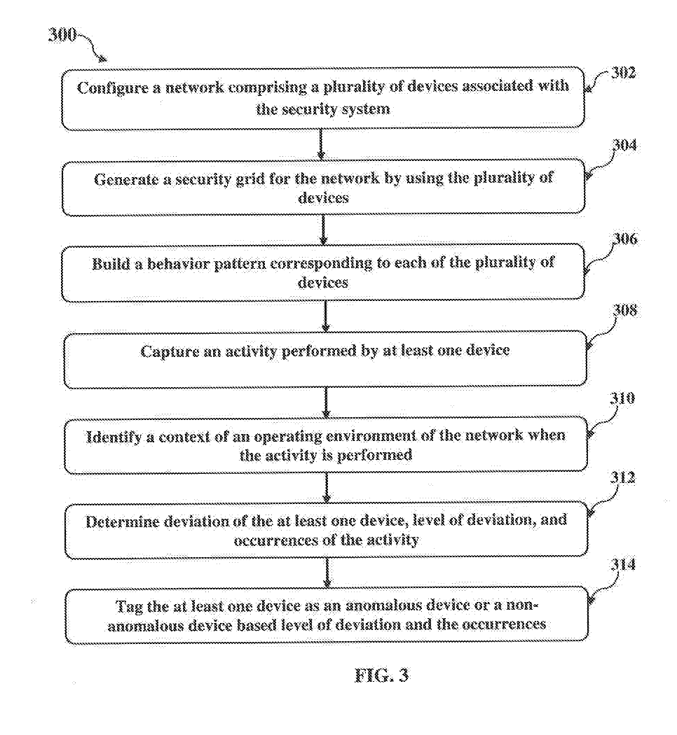

FIG. 3 shows a flowchart illustrating a method for facilitating network security in an enterprise in accordance with some embodiments of the present disclosure.

As illustrated in FIG. 3, the method 300 includes one or more blocks illustrating a method of facilitating network security using security system 102. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, the method 300 includes configuring, by a security system 102, a network comprising a plurality of devices 103 associated with the security system 102. Further, each of the plurality of devices 103 is provided with one or more sensors 104 for detecting one or more security threats or anomalies in behavior of the plurality of devices. According to an embodiment, the one or more sensors 104 may include at least one of anti-malware sensor, anti-phishing sensor, anti-bot sensor, anti-data theft sensor, and anti-ransomware sensor.

At block 304, the method 300 includes generating, by the security system 102, a security grid 105 for the network by using the plurality of devices 103 such that the one or more sensors 104 of one device 103, of the plurality of devices 103, is peered with the one or more sensors 104 of other devices 103.

At block 306, the method 300 includes building, by the security system 102, a behavior pattern corresponding to each of the plurality of devices 103. The behavior pattern is built by continuously monitoring and learning from one or more security related events being captured by the one or more sensors 104. In an embodiment, the one or more security related events may be associated with at least one of a network environment, processes, services, registry, and hardware interrupts. For example, the device 103 may receive an email from unknown sender (i.e., sender is not in sender list). In this example, the anti-phishing sensor may monitor the email closely. In another example, the user may read the email and may click on a link mentioned in the email. Further, the other security related events may include downloading of an office document, opening and executing a script, connecting to a malicious website. According to an embodiment, the anti-bot sensor may stop the service and inform the abnormality to the security system 102.

At block 308, the method 300 includes capturing, by the security system 102, an activity performed by at least one device of the plurality of devices 103. In an embodiment, the activity may include at least one of login activity, email reading, opening of an attachment, browsing internet, visiting website, downloading software, and installing software.

At block 310, the method 300 includes identifying, by the security system 102, a context of an operating environment of the network when the activity is performed. The operating environment may include one or more operating parameters 218 of the network. Further, the one or more operating parameters 218 includes geography associated with the plurality of devices 103, type of network, and type of applications and type of operating system running on the plurality of devices 103.

At block 312, the method 3110 includes determining, by the security system 102, a deviation of the at least one device 103 by comparing the activity with the behavior pattern associated with the at least one device 103, a level of the deviation based on the context of the operating environment, and occurrences of the activity performed by the other devices 103, apart from the at least one device 103, of the plurality of devices 103.

At block 314, the method 300 includes tagging, by the security system 102, the at least one device 103 as an anomalous device or a non-anomalous device based on the level of deviation and the occurrences of the activity.

### Computer System

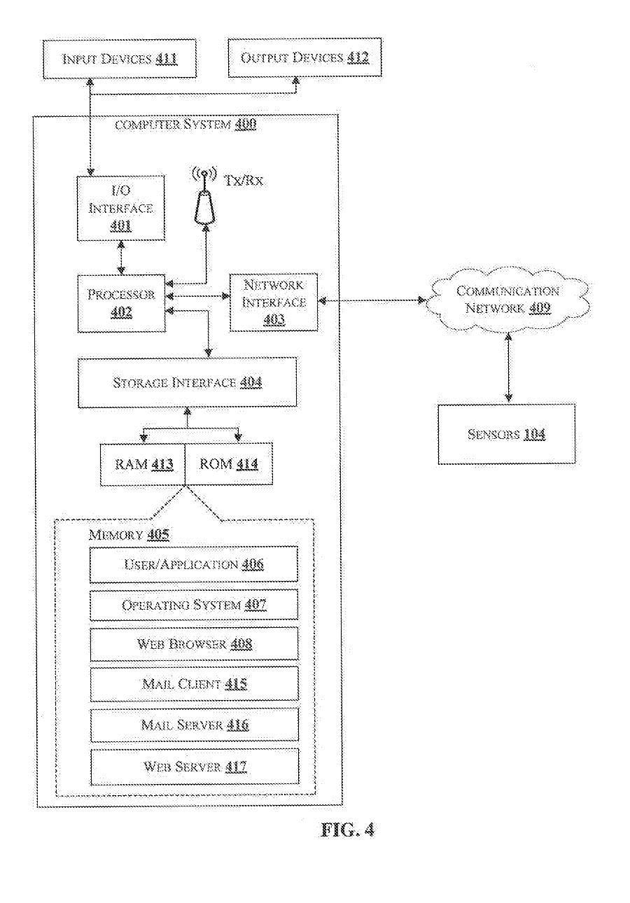

FIG. 4 illustrates a block diagram of an exemplary computer system 400 for implementing embodiments consistent with the present disclosure. In an embodiment, the computer system 400 may be the security system 102 which is used for facilitating network security. The computer system 400 may include a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412). In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with the plurality of devices 103. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application 406, an operating system 407, web browser 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interface may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the compute system 400 may implement a web browser 408. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server 416 may be an Internet mail server such as Microsoft Exchange, or the like. The mail server 416 may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mall Transfer Protocol (SMTP), or the like. In some embodiments, the computer system 400 may implement a mail client 415. The mail client 415 may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure Are Illustrated Herein

In an embodiment, the present disclosure provides a method for facilitating network security considering different perspectives associated with the network, thereby making the method robust.

In an embodiment, the method of the present disclosure provides a minimal human interaction while facilitating the network security.

In an embodiment, the method of the present disclosure provides self-learning from the activities of the devices monitored in the network.

In an embodiment, the method of the present disclosure helps in reducing the management overheads by providing end-to-end management of the security threats.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

| Reference Number | Description |
|---|---|
| 100 | ENVIRONMENT |
| 102 | SECURITY SYSTEM |
| 103 | DEVICE |
| 104 | SENSOR(S) |
| 105 | SECURITY GRID |
| 202 | I/O INTERFACE |
| 204 | PROCESSOR |
| 206 | MEMORY |
| 208 | DATA |
| 210 | MODULES |
| 212 | SENSOR DATA |
| 214 | BEHAVIOR PATTERN |
| 216 | ACTIVITY |
| 218 | OPERATING PARAMETERS |
| 220 | CURATIVE ACTIONS |
| 222 | OTHER DATA |
| 224 | CONFIGURING MODULE |
| 226 | GENERATING MODULE |
| 228 | BUILDING MODULE |
| 230 | CAPTURING MODULE |
| 232 | IDENTIFYING MODULE |
| 234 | DETERMINING MODULE |
| 236 | TAGGING MODULES |
| 238 | TRANSMITTING MODULES |
| 240 | OTHER MODULES |

1. A method of facilitating network security, the method comprising:
configuring, by a security system, a network comprising a plurality of devices associated with the security system, wherein each of the plurality of devices is provided with one or more sensors for detecting one or more security threats or anomalies in behavior of the plurality of devices;
generating, by the security system, a security grid for the network by using the plurality of devices such that the one or more sensors of one device, of the plurality of devices, is peered with the one or more sensors of other devices;
building, by the security system, a behavior pattern corresponding to each of the plurality of devices, wherein the behavior pattern is built by continuously monitoring and learning from one or mom security related events being captured by the one or more sensors;
capturing, by the security system, an activity performed by at least one device of the plurality of devices;
identifying, by the security system, a context of an operating environment of the network when the activity is performed, wherein the operating environment comprises one or more operating parameters of the network;
determining, by the security system,
a deviation of the at least one device by comparing the activity with the behavior pattern associated with the at least one device,
a level of the deviation based on the context of the operating environment, and
occurrences of the activity performed by the other devices, apart from the at least one device, of the plurality of devices; and
tagging, by the security system, the at least one device as an anomalous device or a non-anomalous device based on the level of deviation and the occurrences of the activity.

2. The method as claimed in claim 1, wherein the activity includes at least one of login activity, email reading, opening of an attachment, browsing internet, visiting website, downloading software, and installing software.

3. The method as claimed in claim 1, wherein the one or more sensors includes at least one of anti-malware sensor, anti-phishing sensor, anti-bot sensor, anti-data theft sensor, and anti-ransomware sensor.

4. The method as claimed in claim 1, wherein one or more security related events is associated with at least one of a network environment, processes, services, registry, and hardware interrupts.

5. The method as claimed in claim 1, wherein the one or more operating parameters includes geography associated with the plurality of devices, type of network, and type of applications and type of operating system running on the plurality of devices.

6. The method as claimed in claim 1, further comprising generating one or more curative actions for the at least one device and the other devices when the least one device is determined as the anomalous device, wherein the one or more curative actions are generated to address anomaly in behavior of the at least one device and the other devices due to the deviation.

7. The method as claimed in claim 6, further comprising transmitting the one or more curative actions to the at least one device and the other devices.

8. A security system for facilitating network security, the system comprising:
a processor; and
a memory communicatively coupled to the processor, wherein the memory stores processor-executable instructions, which, on execution, causes the processor to:
configure a network comprising a plurality of devices associated with the security system, wherein each of the plurality of devices is provided with one or more sensors for detecting one or more security threats or anomalies in behavior of the plurality of devices;
generate a security grid for the network by using the plurality of devices such that the one or more sensors of one device, of the plurality of devices, is peered with the one or more sensors of other devices;
build a behavior pattern corresponding to each of the plurality of devices, wherein the behavior pattern is built by continuously monitoring and learning from one or more security related events being captured by the one or more sensors;
capture an activity performed by at least one device of the plurality of devices;
identify a context of an operating environment of the network when the activity is performed, wherein the operating environment comprises one or more operating parameters of the network;
determine,
a deviation of the at least one device by comparing the activity with the behavior pattern associated with the at least one device,
a level of the deviation based on the context of the operating environment,
and
occurrences of the activity performed by the other devices, apart from the at least one device, of the plurality of devices; and
tag the at least one device as an anomalous device or a non-anomalous device based on the level of deviation and the occurrences of the activity.

9. The security system, claimed in claim 8, wherein the activity includes at least one of login activity, email reading, opening of an attachment, browsing internet, visiting website, downloading software, and installing software.

10. The security system claimed in claim 8, wherein the one or more sensors includes at least one of anti-malware sensor, anti-phishing sensor, anti-bot sensor, anti-data theft sensor, and anti-ransomware sensor.

11. The security system claimed in claim 8, wherein one or more security related events is associated with at least one of a network environment, processes, services, registry, and hardware interrupts.

12. The security system claimed in claim 8, wherein the one or more operating parameters includes geography associated with the plurality of devices, type of network, and type of applications and type of operating system running on the plurality of devices.

13. The security system claimed in claim 8, wherein the processor is further configured to generate one or more curative actions for the at least one device and the other devices when the least one device is determined as the anomalous device, wherein the one or more curative actions are generated to address anomaly in behavior of the at least one device and the other devices due to the deviation

14. The security system claimed in claim 13, wherein the processor is further configured to transmit the one or more curative actions to the at least one device and the other devices.

15. A non-transitory computer-readable storage medium including instructions stored thereon that when processed by at least one processor cause a security system to perform operations comprising:
configuring a network comprising a plurality of devices associated with the security system, wherein each of the plurality of devices is provided with one or more sensors for detecting one or more security threats or anomalies in behavior of the plurality of devices;
generating a security grid for the network by using the plurality of devices such that the one or more sensors of one device, of the plurality of devices, is peered with the one or more sensors of other devices;
building a behavior pattern corresponding to each of the plurality of devices, wherein the behavior pattern is built by continuously monitoring and learning from one or more security related events being captured by the one or more sensors;
capturing an activity performed by at least one device of the plurality of devices;
identifying a context of an operating environment of the network when the activity is performed, wherein the operating environment comprises one or more operating parameters of the network;
determining,
a deviation of the at least one device by comparing the activity with the behavior pattern associated with the at least one device,
a level of the deviation based on the context of the operating environment, and
occurrences of the activity performed by the other devices, apart from the at least one device, of the plurality of devices; and
tagging the at least one device as an anomalous device or a non-anomalous device based on the level of deviation and the occurrences of the activity.

16. The medium as claimed in claim 15, wherein the activity includes at least one of login activity, email reading, opening of an attachment, browsing internet, visiting website, downloading software, and installing software.

17. The medium as claimed in claim 15, wherein the one or more sensors includes at least one of anti-malware sensor, anti-phishing sensor, anti-bot sensor, anti-data theft sensor, and anti-ransomware sensor.

18. The medium as claimed in claim 15, wherein one or more security related events is associated with at least one of a network environment, processes, services, registry, and hardware interrupts.

19. The medium as claimed in claim 15, wherein the one or more operating parameters includes geography associated with the plurality of devices, type of network, and type of applications and type of operating system running on the plurality of devices.

20. The medium as claimed in claim 15, wherein the instructions further cause the at least processor to generate one or more curative actions for the at least one device and the other devices when the least one device is determined as the anomalous device, wherein the one or more curative actions are generated to address anomaly in behavior of the at least one device and the other devices due to the deviation.

21. The medium as claimed in claim 20, wherein the instructions further cause the at least processor to transmit the one or more curative actions to the at least one device and the other devices.
